(19) United States
(12) Patent Application Publication
(10) Pub. No.: US 2025/0048462 A1
(43) Pub. Date: Feb. 6, 2025

(54) COMMUNICATION DEVICE, COMMUNICATION SYSTEM, COMMUNICATION DEVICE CONTROL METHOD, AND NON-TRANSITORY COMPUTER READABLE MEDIUM

(71) Applicant: CANON KABUSHIKI KAISHA, Tokyo (JP)

(72) Inventor: TETSUYA KATSURAGI, Tokyo (JP)

(21) Appl. No.: 18/918,394

(22) Filed: Oct. 17, 2024

Related U.S. Application Data
(63) Continuation of application No. PCT/JP2023/013455, filed on Mar. 31, 2023.

(30) Foreign Application Priority Data
Apr. 21, 2022 (JP) 2022-069874

(51) Int. Cl. H04W 76/14; G06T 7/73; H04W 72/40

(52) U.S. Cl. CPC H04W 76/14; G06T 7/73; H04W 72/40; G06T 2207/30252

(57) ABSTRACT

A communication device includes an extraction unit that extracts, from a captured image, a feature of a transmission destination present in the captured image, a generation unit that generates a Layer-2 ID including feature information indicating the feature, and a transmission unit that transmits information using a Sidelink communication method using the Layer-2 ID.

### CROSS-REFERENCE TO RELATED APPLICATIONS

This application is a Continuation of International Patent Application No. PCT/JP2023/013455, filed Mar. 31, 2023, which claims the benefit of Japanese Patent Application No. 2022-069874, filed Apr. 21, 2022, both of which are hereby incorporated by reference herein in their entirety.

### TECHNICAL FIELD

The present invention relates to a communication device, a communication system, a communication device control method, and a non-transitory computer readable medium.

### BACKGROUND ART

In recent years, the 3rd Generation Partnership Project (3GPP®) Long Term Evolution (LTE) and Next Generation (NR) specifications have been developed. Among these, a standard specification called Sidelink communication is being developed. This specification enables direct wireless communication between devices using an interface called PC5 without using a mobile communication network (core network). In Sidelink communication, Layer-2 IDs (hereinafter also referred to as L2IDs) are used as identifiers to indicate transmission source and destination devices.

For example, PTL 1 discloses a technology that uses a communication identifier corresponding to a specific management area located around the current position of a communication terminal device as the communication identifier of a transmission destination in order to achieve vehicle-to-vehicle communication.

### CITATION LIST

### Patent Literature

PTL 1: Japanese Patent Laid-Open No. 2020-188405

However, in the technology of PTL 1, for example, even when the user wants to notify a specific other vehicle of highly urgent information detected by a camera or sensor, unrelated vehicles also respond at the same time, and it takes time before the exchange of information with the desired partner begins.

The problem to be solved by the present invention is to achieve Sidelink communication with a specific communication partner even in locations where there are multiple possible communication partners.

### SUMMARY OF INVENTION

In order to solve the above-described problem, a communication device according to one aspect of the present invention includes an extraction unit that extracts, from a captured image, a feature of a transmission destination present in the captured image, a generation unit that generates a Layer-2 ID including feature information indicating the feature, and a transmission unit that transmits information using a Sidelink communication method using the Layer-2 ID.

A communication device according to another aspect of the present invention includes a storage unit that stores a feature that is extractable from a captured image, the feature being a feature of a loading body equipped with the communication device, and a reception unit that receives information using a Sidelink communication method using a Layer-2 ID including feature information indicating the feature.

Further features of the present invention will become apparent from the following description of exemplary embodiments with reference to the attached drawings.

### BRIEF DESCRIPTION OF DRAWINGS

The attached drawings are included in the specification, form part of the specification, and are used to illustrate embodiments of the present invention and describe the principles of the present invention together with its description.

FIG. 1 is a diagram schematically illustrating an example of the configuration of a communication system according to an embodiment of the present invention.

FIG. 2 is a block diagram illustrating an example of the functional configuration of a roadside device according to the present embodiment.

FIG. 3 is a block diagram illustrating an example of the functional configuration of in-vehicle devices and communication devices according to the present embodiment.

FIG. 4 is a diagram illustrating an example of the hardware configuration of the roadside device, the in-vehicle devices, and the communication devices.

FIG. 5 is a diagram illustrating a first example of a Layer-2 ID generated by identification (ID) generation units.

FIG. 6 is a diagram illustrating a second example of a Layer-2 ID generated by the ID generation units.

FIG. 7 is a diagram illustrating a third example of a Layer-2 ID generated by the ID generation units.

FIG. 8 is a diagram illustrating a communication sequence in, for example, a “broadcast communication method”.

FIG. 9 is a diagram illustrating a communication sequence in a “unicast communication method”.

FIG. 10 is a diagram illustrating a communication sequence between an in-vehicle device of vehicle A and the roadside device.

FIG. 11 is a diagram illustrating a communication sequence between the roadside device and a communication device of a pedestrian.

FIG. 12 is a diagram illustrating a communication sequence between the roadside device and a communication device of a bicycle.

FIG. 13 is a diagram illustrating a communication sequence performed interactively between in-vehicle devices.

FIG. 14 is a flowchart when the roadside device or the like serves as a transmission device.

FIG. 15 is a flowchart when the in-vehicle device of vehicle A serves as a reception device.

FIG. 16 is a flowchart when the communication device of the pedestrian serves as a reception device.

FIG. 17 is a flowchart when the communication device of the bicycle serves as a reception device.

### DESCRIPTION OF EMBODIMENTS

Other features and advantages of the present invention will become apparent from the following description with reference to the attached drawings. In the attached drawings, the same or similar configurations are denoted by the same reference numbers. The following is a detailed description of the embodiments of the present invention with reference to the attached drawings. Note that the following embodiments are not intended to limit the present invention. Not all of the combinations of multiple features described in the embodiments are essential to the solutions of the present invention, and the multiple features may be combined freely. The configurations of the embodiments may be modified or changed as appropriate depending on the specifications and various conditions (use conditions, use environments, for example) of systems and apparatuses to which the present invention is applied.

The technical scope of the present invention is defined by the claims and not by the following individual embodiments. Furthermore, in the attached drawings, the same or substantially the same configurations are denoted by the same reference signs, and redundant description will be omitted. Constitutional elements and other elements illustrated in the previously described drawings may be cited as appropriate in the description of the later drawings.

### Configuration of Communication System

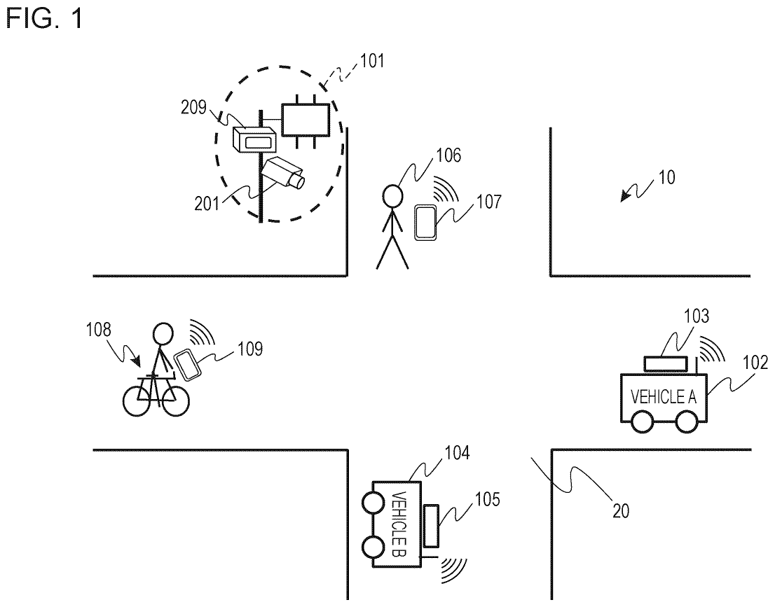

FIG. 1 is a diagram schematically illustrating an example of the configuration of a communication system according to an embodiment of the present invention.

A communication system 10 according to the present embodiment includes, as an example, a roadside device 101, in-vehicle devices 103 and 105, and portable communication devices 107 and 109.

The roadside device 101 is installed near an intersection 20 or on the side of the road, for example, to determine traffic conditions and other factors on the basis of images captured by a camera 201 and detection signals from a sensor 209. The roadside device 101 notifies vehicles 102 and 104, a pedestrian 106, and the rider of a bicycle 108 of notification information regarding the determined traffic conditions and other information. Notification of the notification information is performed via Sidelink communication. In addition to its own detection results, the roadside device 101 may use information from outside sources, such as servers on the Internet, for example, to determine the conditions and notify vehicles and pedestrians via Sidelink communication of the information.

The in-vehicle devices 103 and 105 are mounted in or on the vehicles 102 and 104 traveling on the road and communicate with devices outside the vehicles. In the following description, in a case where the two vehicles 102 and 104 illustrated in FIG. 1 are distinguished from each other, the vehicle 102 is referred to as vehicle A and the other vehicle 104 is referred to as vehicle B. That is, one of the two in-vehicle devices 103 and 105 is mounted in or on vehicle A, and the other in-vehicle device 105 is mounted in or on vehicle B. The in-vehicle devices 103 and 105 acquire and display information from outside the vehicles via Sidelink communication, and acquire information regarding the vehicles 102 and 104 to share the information with external devices via Sidelink communication.

Among the two portable communication devices 107 and 109 illustrated in FIG. 1, the communication device 107 is carried by the pedestrian 106 who is passing near the intersection 20. The other communication device 109 is installed on the bicycle 108 passing through the intersection 20 or is carried by the rider of the bicycle 108. Note that, in the following description, the bicycle 108 and the rider of the bicycle 108 may be referred to simply as “bicycle” without distinguishing between the bicycle 108 and the rider of the bicycle 108. For example, the following cases where something is mounted on the bicycle 108 include situations where it is carried by the rider of the bicycle 108.

The portable communication devices 107 and 109 acquire and display information transmitted to the pedestrian 106 and the bicycle 108 via Sidelink communication or acquire information regarding the pedestrian 106 and the bicycle 108 to share the information with external devices via Sidelink communication.

### Functional Configurations of Devices

Next, the functional configurations of the roadside device 101 and in-vehicle devices 103 and 105 and communication devices 107 and 109 of the communication system 10 will be described.

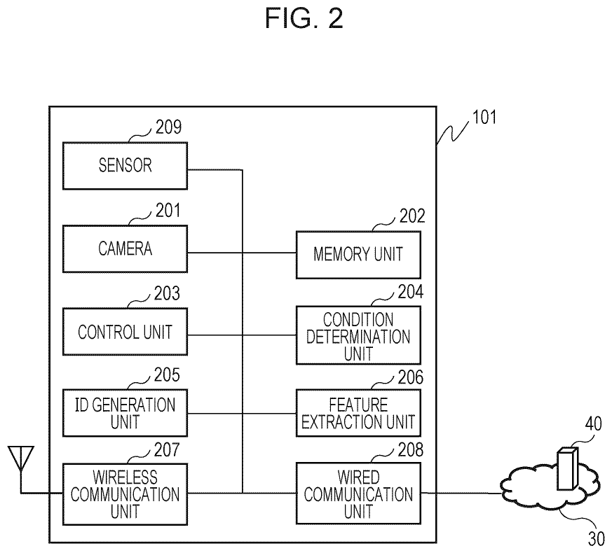

FIG. 2 is a block diagram illustrating an example of the functional configuration of the roadside device 101 according to the present embodiment.

The roadside device 101 includes, as a functional configuration, the camera 201, a memory unit 202, a control unit 203, a condition determination unit 204, an identification (ID) generation unit 205, a feature extraction unit 206, a wireless communication unit 207, a wired communication unit 208, and the sensor 209.

The camera 201 captures images of traffic conditions and other conditions at the intersection 20 or on the roads and also captures images of the vehicles 102 and 104, pedestrian 106, and bicycle 108 at the intersection 20 or near the roads.

The memory unit 202 stores the captured images obtained by the camera 201 and information obtained through communication.

The control unit 203 controls the overall operation of the roadside device 101.

The condition determination unit 204 processes the captured images obtained by the camera 201 and the detection signals obtained by the sensor 209 to determine the traffic conditions. The condition determination unit 204 generates notification information indicating the determined traffic conditions.

The ID generation unit 205 generates Layer-2 IDs for each of the vehicles 102 and 104, the pedestrian 106, and the bicycle 108, the Layer-2 IDs each including feature information indicating features of a corresponding one of the vehicles 102 and 104, the pedestrian 106, and the bicycle 108.

The feature extraction unit 206 extracts features of each of the vehicles 102 and 104, the pedestrian 106, and the bicycle 108, which are transmission destinations, present in the captured images obtained by the camera 201.

The wireless communication unit 207 transmits and receives information to and from external wireless devices (namely the in-vehicle devices 103 and 105, the communication devices 107 and 109, and other devices) via Sidelink communication. That is, the wireless communication unit 207 transmits information via Sidelink communication using the Layer-2 IDs generated by the ID generation unit 205. In the present embodiment, Sidelink communication is Sidelink communication (PC5) specified by the 3GPP, and the Layer-2 IDs are identifiers that indicate the destinations of communication in Sidelink communication specified by the 3GPP.

The wired communication unit 208 is connected to Internet 30 by wire and acquires information from other devices such as a server 40. Information acquired from other devices may be used by the condition determination unit 204 to determine traffic conditions, and may also be used to generate feature information indicating features.

The sensor 209 detects events, such as vehicle congestion and weather, that are useful for determining traffic conditions at the intersection 20 or on the roads.

The roadside device 101 determines the traffic conditions at the intersection 20 and on the roads at specific times by processing, using the condition determination unit 204, images captured by the camera 201 and detection signals from the sensor 209.

In contrast, the roadside device 101 extracts, using the feature extraction unit 206, features of each of the vehicles 102 and 104, pedestrian 106, and bicycle 108 that are present in the images captured at specific times by the camera 201.

In a case where the condition determination unit 204 generates notification information indicating a traffic condition to be reported to any one of the vehicles 102 and 104, the pedestrian 106, and the bicycle 108, the roadside device 101 transmits the notification information using the wireless communication unit 207. The roadside device 101 selects, on the basis of the traffic condition indicated by the information, a transmission destination of the notification information from among the vehicles 102 and 104, pedestrian 106, and bicycle 108 present in the captured images.

When the roadside device 101 transmits notification information using the wireless communication unit 207, the roadside device 101 uses, as an identifier, a Layer-2 ID including feature information indicating features of a transmission destination. This allows the roadside device 101 to identify the transmission destination and transmit the notification information to the transmission destination even in a case where multiple devices capable of communicating are present near the intersection 20.

Note that, in addition to the feature information indicating the features extracted from the images captured by the camera 201, the roadside device 101 may also use feature information regarding the transmission destination of the notification information and acquired via the wired communication unit 208 from external devices, such as the server 40, to generate a Layer-2 ID.

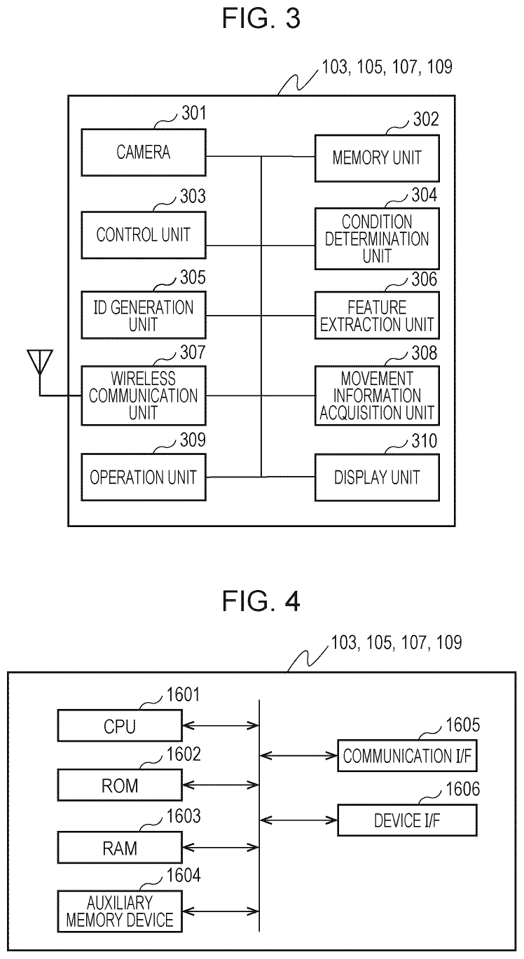

FIG. 3 is a block diagram illustrating an example of the functional configuration of the in-vehicle devices 103 and 105 and communication devices 107 and 109 according to the present embodiment. In the present embodiment, the in-vehicle devices 103 and 105 and the communication devices 107 and 109 have a common functional configuration.

The in-vehicle devices 103 and 105 and the communication devices 107 and 109 include, as a functional configuration, a camera 301, a memory unit 302, a control unit 303, a condition determination unit 304, an ID generation unit 305, and a feature extraction unit 306. The in-vehicle devices 103 and 105 and the communication devices 107 and 109 also include, as a functional configuration, a wireless communication unit 307, a movement information acquisition unit 308, an operation unit 309, and a display unit 310.

The camera 301 captures images of the surrounding conditions of the vehicle 102, the vehicle 104, the pedestrian 106, or the bicycle 108. Note that the camera 301 is not essential as a function of the in-vehicle devices 103 and 105 and communication devices 107 and 109. For example, the in-vehicle devices 103 and 105 may acquire captured images from drive recorders or other devices that the vehicles 102 and 104 have. The communication devices 107 and 109 do not have to capture images.

The memory unit 302 stores the captured images obtained by the camera 301 and information obtained through communication. The memory units 302 also store features, which can be extracted from the captured images, of the vehicles 102 and 104, pedestrian 106, and bicycle 108 that are loading bodies equipped with the devices that include the memory units 302.

The control units 303 control the overall operations of the in-vehicle devices 103 and 105 and communication devices 107 and 109.

The condition determination unit 304 determines traffic conditions by processing captured images obtained by the camera 201 and generates notification information indicating the determined traffic conditions.

The ID generation unit 305 generates a Layer-2 ID including feature information indicating features of a communication partner among the vehicles 102 and 104, the pedestrian 106, and the bicycle 108.

In the present embodiment, the ID generation units 305 also generate Layer-2 IDs for information reception, including feature information that indicates the features of the vehicles 102 and 104, pedestrian 106, and bicycle 108 equipped with the devices that include the ID generation units 305. Note that predetermined Layer-2 IDs may be stored in the memory units 302 and used for reception without being generated by the ID generation units 305.

The feature extraction unit 306 extracts features of a communication partner from captured image obtained by the camera 201.

The wireless communication unit 307 transmits and receives information to and from external devices via Sidelink communication.

The wireless communication units 307 wait for Sidelink communication using Layer-2 IDs that include feature information indicating the features of the vehicles 102 and 104, pedestrian 106, and bicycle 108 equipped with the devices that include the wireless communication units 307, and receive information via Sidelink communication using the Layer-2 IDs.

The movement information acquisition units 308 acquire position, speed, and other information regarding the vehicles 102 and 104, pedestrian 106, and bicycle 108 equipped with the devices that include the movement information acquisition units 308. The movement information acquisition units 308 acquire position, speed, and other information from, for example, GPS circuits included in the devices that include the movement information acquisition units 308. In a case where the devices including the movement information acquisition units 308 are the in-vehicle devices 103 and 105, the movement information acquisition units 308 may acquire position, speed, and other information from the navigation systems of the vehicles 102 and 104.

The operation units 309 accept operations performed on the in-vehicle devices 103 and 105 and the communication devices 107 and 109.

The display unit 310 display, for example, the traffic conditions indicated by notification information received from another device.

The in-vehicle devices 103 and 105 and communication devices 107 and 109 store, in the memory units 302, the features of the vehicles 102 and 104, pedestrian 106, and bicycle 108 that are equipped with the in-vehicle devices 103 and 105 and communication devices 107 and 109, respectively, the features having been input from the operation units 309 in advance. In the case of, for example, the in-vehicle devices 103 and 105, the features of the vehicles 102 and 104 equipped with the in-vehicle devices 103 and 105 may be automatically acquired from the vehicles 102 and 104, respectively, and stored in the memory units 302.

Features are stored in the memory units 302, for example, in the form of feature information used by the ID generation units 305 to generate Layer-2 IDs. The memory units 302 may store features in the form of pre-generated Layer-2 IDs. The memory units 302 may store features in other forms that can be converted to Layer-2 IDs or feature information.

Since the in-vehicle devices 103 and 105 and the communication devices 107 and 109 use Layer-2 IDs that include feature information indicating the features of their own devices when waiting for notification information indicating traffic conditions, the in-vehicle devices 103 and 105 and the communication devices 107 each receive only notification information transmitted specifically thereto. Information reception performed by each of the in-vehicle devices 103 and 105 and communication devices 107 and 109 is not limited to cases where the entire feature information included in the Layer-2 ID matches. That is, in a case where feature information indicates multiple features, the in-vehicle devices 103 and 105 and the communication devices 107 and 109 may each receive notification information using the Layer-2 ID in which some of the multiple features match.

In the present embodiment, the in-vehicle devices 103 and 105 and communication devices 107 and 109 also have the function of determining the surrounding conditions of their own devices and transmitting notification information to other devices. That is, the in-vehicle devices 103 and 105 and the communication devices 107 and 109 process, using the condition determination units 304, images captured by the camera 301 to determine the surrounding traffic conditions. In a case where a traffic condition to be reported to other devices occurs, the in-vehicle devices 103 and 105 and communication devices 107 and 109 each transmit notification information using the wireless communication units 307.

Note that the communication devices 107 and 109 may only receive information without having the function of transmitting notification information to other devices. In a case where the communication devices 107 and 109 only receive notification information, the communication devices 107 and 109 do not have the condition determination units 304, and the cameras 301 are not necessary for the communication devices 107 and 109.

In the present embodiment, the in-vehicle devices 103 and 105 and communication devices 107 and 109 generate Layer-2 IDs, which are identifiers for transmission. The in-vehicle devices 103 and 105 and communication devices 107 and 109 extract features of, for example, vehicles and pedestrians present in captured images using the feature extraction units 306. The in-vehicle devices 103 and 105 and communication devices 107 and 109 select transmission destinations corresponding to traffic conditions to be reported, from among, for example, the vehicles and pedestrians present in the captured images.

The in-vehicle devices 103 and 105 and communication devices 107 and 109 use, as identifiers, Layer-2 IDs including feature information indicating the features of the transmission destinations to transmit information regarding traffic conditions using the wireless communication units 307. This allows the in-vehicle devices 103 and 105 and the communication devices 107 and 109 to identify transmission destinations and transmit information even in a case where there are multiple devices capable of communicating in the surrounding area.

The configurations illustrated in FIGS. 2 and 3 are examples, and some (or all in some cases) of the functional blocks may be replaced with other functional blocks that realize similar functions, some functional blocks may be omitted, or further functional blocks may be added. One functional block illustrated in the following description may be divided into multiple functional blocks, or multiple functional blocks may be combined into a single functional block.

### Hardware Configuration

In the present embodiment, the roadside device 101, the in-vehicle devices 103 and 105, and the communication devices 107 and 109 have hardware configurations similar to each other. In the following description, the roadside device 101, the in-vehicle devices 103 and 105, and the communication devices 107 and 109 are collectively referred to as “the roadside device 101 or the like”.

FIG. 4 is a diagram illustrating an example of the hardware configuration of the roadside device 101, in-vehicle devices 103 and 105, and communication devices 107 and 109.

The roadside device 101 or the like includes a central processing unit (CPU) 1601, a read-only memory (ROM) 1602, a random access memory (RAM) 1603, an auxiliary memory device 1604, a communication interface (I/F) 1605, and a device interface (I/F) 1606. CPU stands for central processing unit. ROM stands for read-only memory, and RAM stands for random access memory.

The CPU 1601 controls the entire roadside device 101 or the like using computer programs and data stored in the ROM 1602 or the RAM 1603. Control performed by the CPU 1601 realizes each of the functions illustrated in FIGS. 2 and 3.

The ROM 1602 stores programs and other data that do not require modification.

The RAM 1603 temporarily stores programs and data supplied from the auxiliary memory device 1604 and data supplied from outside via the communication I/F 1605.

The auxiliary memory device 1604 includes a hard disk drive, for example, and stores various data.

The communication I/F 1605 is used to communicate with external devices. For example, the wireless communication units 207 and 307 illustrated in FIGS. 2 and 3 perform wireless communication with external devices via the communication I/F 1605.

The device I/F 1606 connects various devices to the roadside device 101 or the like, either as constituent elements of the roadside device 101 or the like or as external elements. For example, the device I/F 1606 can connect, to the roadside device 101, a display device and an input device for the server administrator or others to check information managed by the roadside device 101. The device I/F 1606 can also connect the sensor 209 and the camera 201 to the roadside device 101. The device I/F 1606 can also connect, the in-vehicle device 103 or 105, the camera 301 and sensors of a corresponding one of the vehicles 102 and 104.

FIG. 4 illustrates an example in which the constituent elements illustrated in FIGS. 2 and 3 are realized by a program and the CPU, but the constituent elements illustrated in FIGS. 2 and 3 may be implemented by one or more dedicated hardware devices. When the constituent elements illustrated in FIGS. 2 and 3 are implemented using hardware devices, for example, it is sufficient that dedicated circuits be automatically generated, by using a predetermined compiler, on a field-programmable gate array (FPGA) from the program for realizing each constituent element. FPGA stands for field programmable gate array. A gate array circuit may be formed in substantially the same way as an FPGA and may be realized as a hardware device. The constituent elements may also be realized by an application specific integrated circuit (ASIC).

### About Layer-2 ID and Sidelink Communication

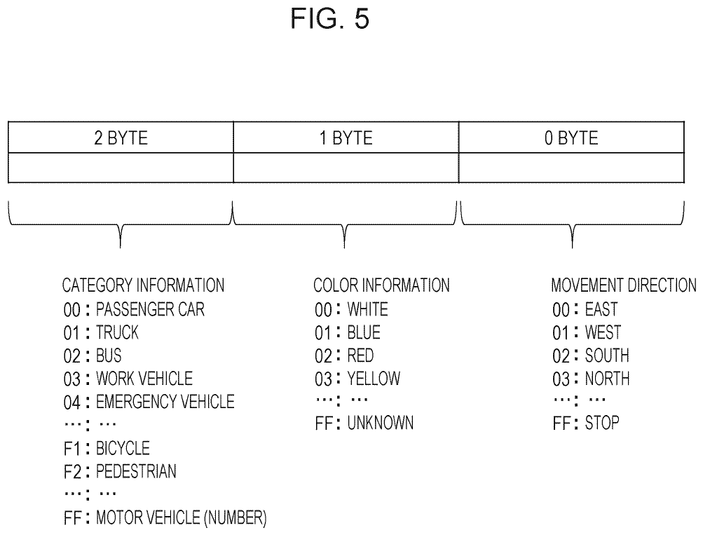

FIGS. 5 to 7 are diagrams illustrating examples of Layer-2 IDs generated by the ID generation units 205 and 305.

Layer-2 IDs, which are identifiers that indicate destinations of communication in Sidelink communication defined by the 3GPP, each have a total of 3 bytes of data. That is, a Layer-2 ID has the most significant byte marked “2 byte”, a middle byte marked “1 byte”, and the least significant byte marked “0 byte” in FIGS. 5 to 7.

The ID generation units 205 and 305 of the roadside device 101, in-vehicle devices 103 and 105, and communication devices 107 and 109 generate Layer-2 IDs illustrated in FIGS. 5 to 7.

The Layer-2 IDs generated by the ID generation units 205 and 305 include feature information as described above.

At least one of the following features of the vehicles 102 and 104 is used as a feature indicated by the feature information: vehicle number, vehicle category, vehicle body shape, vehicle body color, direction of travel, speed, position, occupant count, indicator lamp lighting status, and brake lamp lighting status. Vehicle numbers make it easy to distinguish one vehicle from another, and the numerical values extracted from images are features and can be used simply as feature information. Thus, it is preferable that vehicle numbers be used as the features of the vehicles 102 and 104.

At least one of the following features of the pedestrian 106 is used as a feature indicated by the feature information: clothing, hairstyle, skin color, gender, walking direction, speed, and position. In addition, at least one of the following features of the bicycle 108 is used as a feature indicated by the feature information: vehicle type, vehicle body shape, number of wheels, vehicle body color, rider clothing, rider clothing color, direction of travel, speed, and location. For example, in the case of a bicycle with a vehicle number, such as a rental bicycle, the vehicle number may be used as a feature.

The ID generation units 205 and 305 of the roadside device 101, in-vehicle devices 103 and 105, and communication devices 107 and 109 generate Layer-2 IDs including feature information indicating at least one or more of the above features.

In the example illustrated in FIG. 5, the Layer-2 ID includes feature information indicating the category, color, and direction of movement of the transmission destination. In a case where the most significant byte “2 byte” is, for example, the value “00”, this indicates that the category of the transmission destination is “passenger car”, and in a case where, for example, the most significant byte “2 byte” is the value “F1”, this indicates that the category of the transmission destination is “bicycle”. That is, the value of the most significant byte “2 byte” is feature information indicating the category of the transmission destination.

In a case where the middle byte “1 byte” is, for example, the value “00”, this indicates that the color is “white”, and in a case where the middle byte “1 byte” is the value “01”, this indicates that the color is “blue”. That is, the value of the middle byte “1 byte” is feature information indicating the color.

In a case where the least significant byte “0 byte” is, for example, the value “00”, this indicates that the direction of movement is “East”, and in a case where the least significant byte “0 byte” is the value “01”, this indicates that the direction of movement is “West”. That is, the value of the least significant byte “0 byte” is feature information indicating the direction of movement.

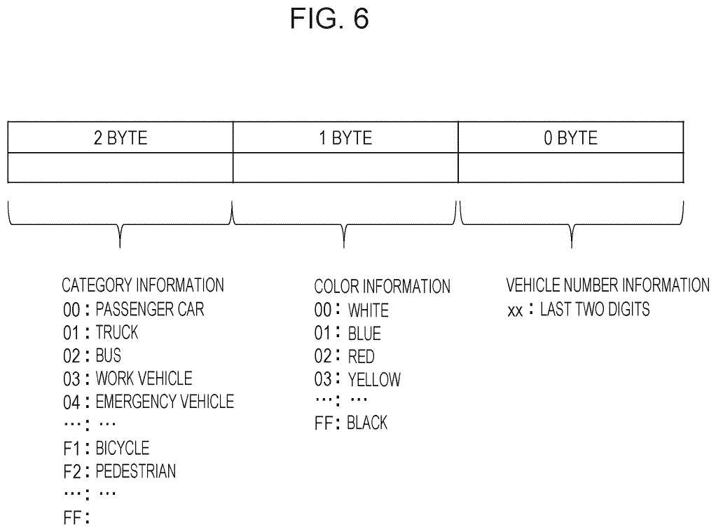

In the example illustrated in FIG. 6, the Layer-2 ID includes feature information indicating the category, color, and vehicle number of the transmission destination. The Layer-2 ID illustrated in FIG. 6 is generated in a case where the vehicle number of the transmission destination is extracted from a captured image.

The value of the most significant byte “2 byte” and that of the middle byte “1 byte” in the Layer-2 ID illustrated in FIG. 6 indicate the category and color of the transmission destination, as in the example illustrated in FIG. 5.

The value of the least significant byte “0 byte” in the Layer-2 ID illustrated in FIG. 6 indicates the last two digits of the vehicle number. That is, the value of the least significant byte “0 byte” is feature information indicating the vehicle number in the example illustrated in FIG. 6.

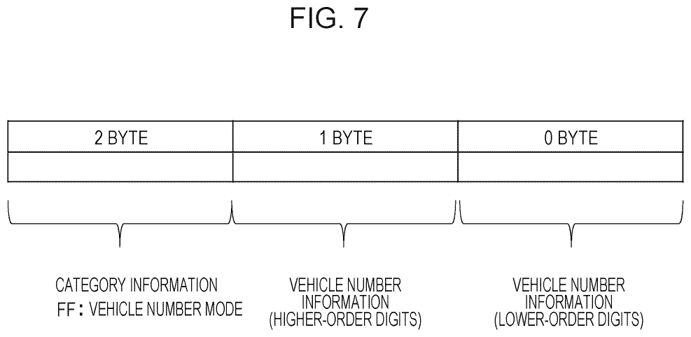

The Layer-2 IDs illustrated in FIGS. 5 and 6 include multiple pieces of feature information indicating multiple features, but the Layer-2 ID in the example illustrated in FIG. 7 includes feature information indicating a single feature. Specifically, the Layer-2 ID illustrated in FIG. 7 includes feature information indicating the vehicle number.

That is, the value “FF” for the most significant byte “2 byte” in the Layer-2 ID illustrated in FIG. 7 indicates that the Layer-2 ID illustrated in FIG. 7 is a Layer-2 ID for vehicle number mode. Then, the value of the middle byte “1 byte” and that of the least significant byte “0 byte” indicate the upper two and lower two digits of the vehicle number, respectively.

The Layer-2 IDs illustrated in FIG. 7 and one of the Layer-2 IDs illustrated in FIGS. 5 and 6 can be used at the same time. That is, in a case where the value of the most significant byte “2 byte” in a Layer-2 ID is other than “FF”, the feature information is interpreted assuming that the Layer-2 ID is the one illustrated in FIG. 5 or 6. In a case where the value of the most significant byte “2 byte” is “FF”, the feature information (namely, vehicle number) is interpreted assuming that the Layer-2 ID is the one illustrated in FIG. 7.

The Layer-2 IDs illustrated in FIGS. 5 to 7 are generated as identifiers for transmission or reception by the ID generation units 205 and 305 of the roadside device 101, in-vehicle devices 103 and 105, and communication devices 107 and 109, and are used to transmit and receive information in Sidelink communication.

In the following, communication methods in Sidelink communication will be described. As communication methods in Sidelink communication, there are a “broadcast communication method”, a “groupcast communication method”, and a “unicast communication method”.

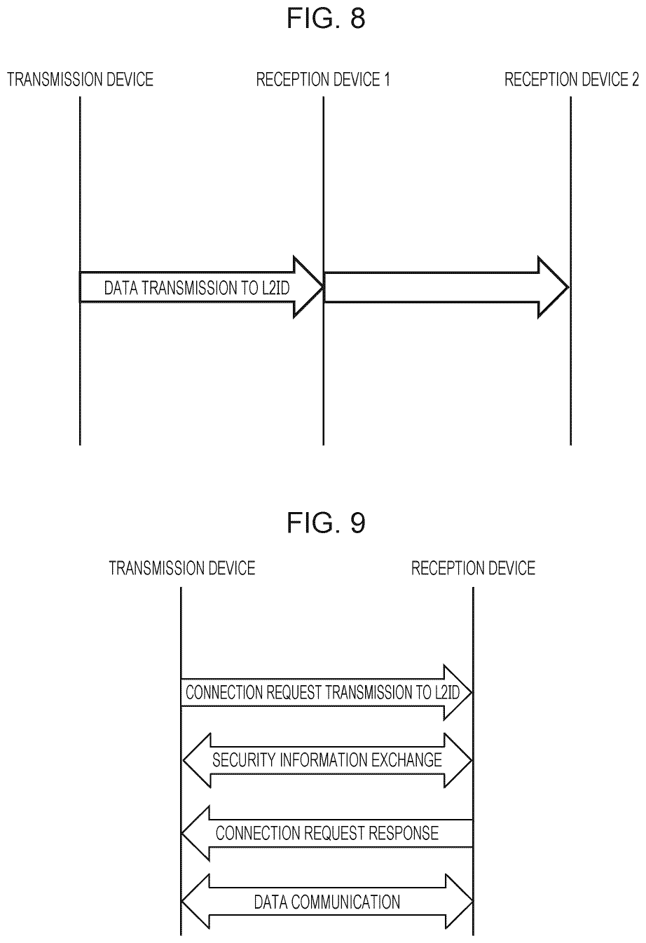

FIG. 8 is a sequence diagram illustrating a communication sequence in the “broadcast communication method” and “groupcast communication method”.

In the “broadcast communication method” and “groupcast communication method”, each Layer-2 ID serving as an identifier (abbreviated as “L2ID” in FIG. 8) is set as a transmission destination and a reception destination in devices on the transmission side and on the reception side (namely transmission and reception devices). The transmission device assigns, to transmission data, the Layer-2 ID that has been set as the transmission destination, and transmits the transmission data. The transmission data is then received by a reception device in which a Layer-2 ID having at least some similarities with the Layer-2 ID assigned to the transmission data is set as the reception destination.

That is, in the “broadcast communication method” and “group-cast communication method”, the setting of Layer-2 IDs in the transmission and reception devices makes it possible to perform data communication between the devices. Therefore, in a case where there are multiple reception devices in which Layer-2 IDs having similarities with the Layer-2 ID assigned to the transmission data are set as the reception destinations, then the multiple reception devices will receive the transmission data simultaneously.

FIG. 9 is a sequence diagram illustrating a communication sequence in the “unicast communication method”.

In the case of the “unicast communication method”, the transmission device transmits a connection request to the transmission destination identified by a Layer-2 ID. On the reception device side, security information is exchanged with the transmission device in a case where a Layer-2 ID having at least some similarities with the Layer-2 ID assigned to the connection request has been set as the reception destination. Once a secure communication link is established through the exchange of security information, data communication becomes possible between the transmission and reception devices.

In the communication system 10 according to the present embodiment, any of the communication methods can be applied; however, in the processing examples described below, the description will assume the use of the “unicast communication method”.

### Example of Processing in Communication System

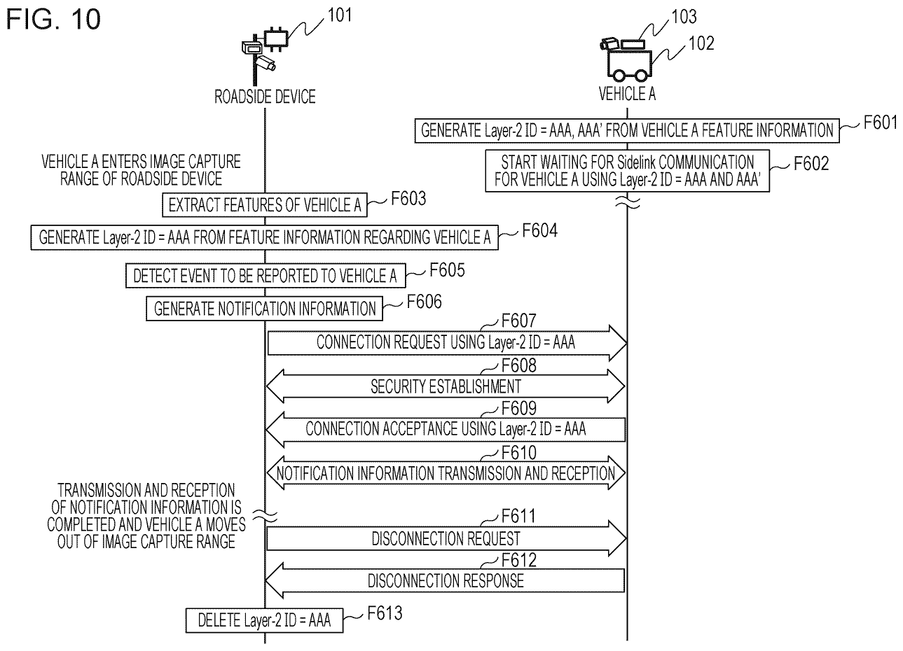

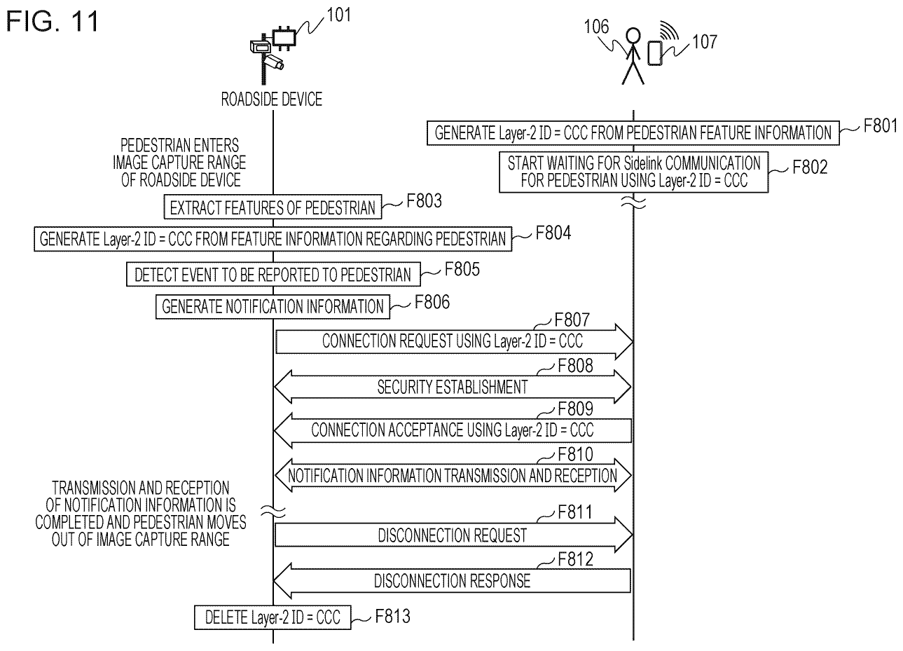

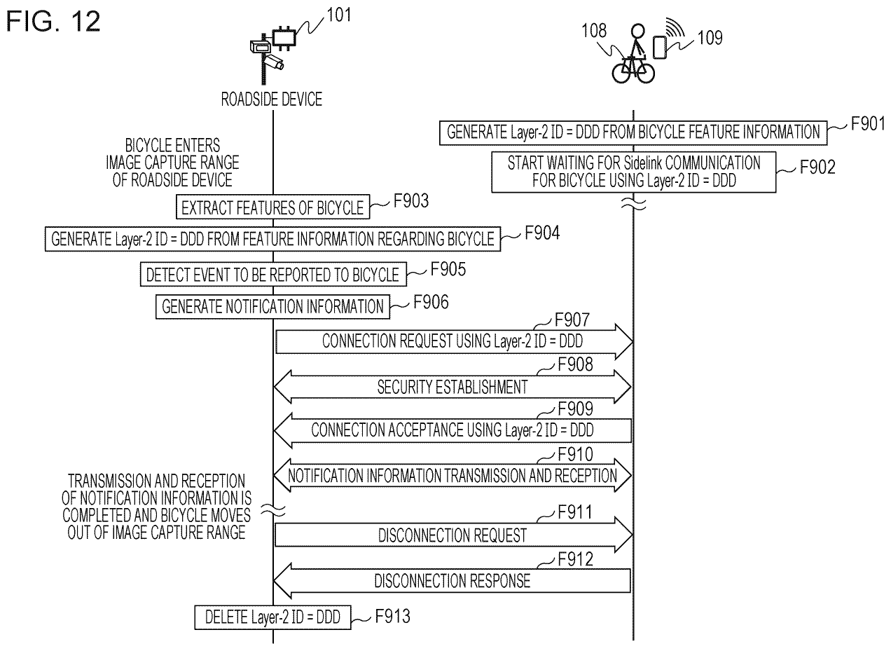

FIGS. 10 to 12 are sequence diagrams illustrating sequences related to communication processing performed between the roadside device 101 and the in-vehicle device 103 and communication devices 107 and 109. FIG. 10 illustrates processing performed between the in-vehicle device 103 of vehicle A, representing the two in-vehicle devices 103 and 105, and the roadside device 101. FIG. 11 illustrates processing performed between the roadside device 101 and the communication device 107 of the pedestrian 106. FIG. 12 illustrates processing performed between the roadside device 101 and the communication device 109 of the bicycle 108. In the following description, the in-vehicle device 103 and the communication devices 107 and 109 are collectively referred to as “the in-vehicle device 103 or the like”.

The in-vehicle device 103 and communication devices 107 and 109 generate Layer-2 IDs for reception from the feature information regarding the vehicle 102, pedestrian 106, and bicycle 108 that are equipped with the in-vehicle device 103 and communication devices 107 and 109, respectively (F601, F801, F901). The in-vehicle device 103 generates, as Layer-2 IDs for reception, two Layer-2 IDs “AAA” and “AAA′” from two respective pieces of feature information, for example. The communication device 107 of the pedestrian 106 generates a Layer-2 ID, such as “CCC”, from feature information indicating the features of the pedestrian 106. The communication device 109 of the bicycle 108 generates a Layer-2 ID, such as “DDD”, from feature information indicating the features of the bicycle 108. Note that the in-vehicle device 103 may generate one Layer-2 ID, or the communication devices 107 and 109 may generate multiple Layer-2 IDs from multiple pieces of feature information.

The in-vehicle device 103 and the communication devices 107 and 109 start waiting for Sidelink communication using the generated Layer-2 IDs (F602, F802, F902).

When the vehicle 102, the pedestrian 106, or the bicycle 108 enters the image capture range of the camera 201 of the roadside device 101, the roadside device 101 extracts features from images captured by the camera 201 (F603, F803, F903). The roadside device 101 then generates a Layer-2 ID for transmission from feature information indicating the extracted features (F604, F804, F904).

When the roadside device 101 detects, using the camera 201 or sensor 209, an event that is to be reported to the vehicle 102, the pedestrian 106, or the bicycle 108 (F605, F805, F905), the roadside device 101 generates notification information (F606, F806, F906).

To transmit the notification information to the in-vehicle device 103 of the vehicle 102 or the like, the roadside device 101 requests a connection using one or more Layer-2 IDs generated in F604, F804, and F904 (F607, F807, F907). When any of the one or more Layer-2 IDs used in the connection request matches any of the waiting Layer-2 IDs, the in-vehicle device 103 and the communication devices 107 and 109 accept the exchange of security information.

In a case where the Layer-2 ID includes multiple pieces of feature information, the in-vehicle device 103 or the like may accept the exchange of security information when some or all of the multiple pieces of feature information match some or all of the pieces of feature information of the waiting Layer-2 IDs.

That is, in a case where, regarding a Layer-2 ID including multiple pieces of feature information, all or some of the multiple pieces of feature information match feature information indicating a feature of the loading body, the in-vehicle device 103 or the like may receive information using the Layer-2 ID.

When the in-vehicle device 103 or the like accepts the exchange of security information, security is established between the roadside device 101 and the in-vehicle device 103 or the like (F608, F808, F908). Once security is established, a connection acceptance is transmitted from the in-vehicle device 103 or the communication device 107 or 109 to the roadside device 101 (F609, F809, F909).

The roadside device 101 that has received the connection acceptance transmits notification information to the in-vehicle device 103 or the like, and the in-vehicle device 103 or the like receives the notification information (F610, F810, F910).

When all notification information has been transmitted and received and the vehicle 102, the pedestrian 106, or the bicycle 108 moves out of the image capturable range of the camera 201 of the roadside device 101, the roadside device 101 requests disconnection of Sidelink communication (F611, F811, F911). When the in-vehicle device 103 or the communication device 107 or 109 accepts the disconnection request (F612, F812, F912), the Sidelink communication is disconnected.

After the Sidelink communication is disconnected, the roadside device 101 deletes (discards) the Layer-2 ID generated in F604, F804, or F904 (F613, F813, F913).

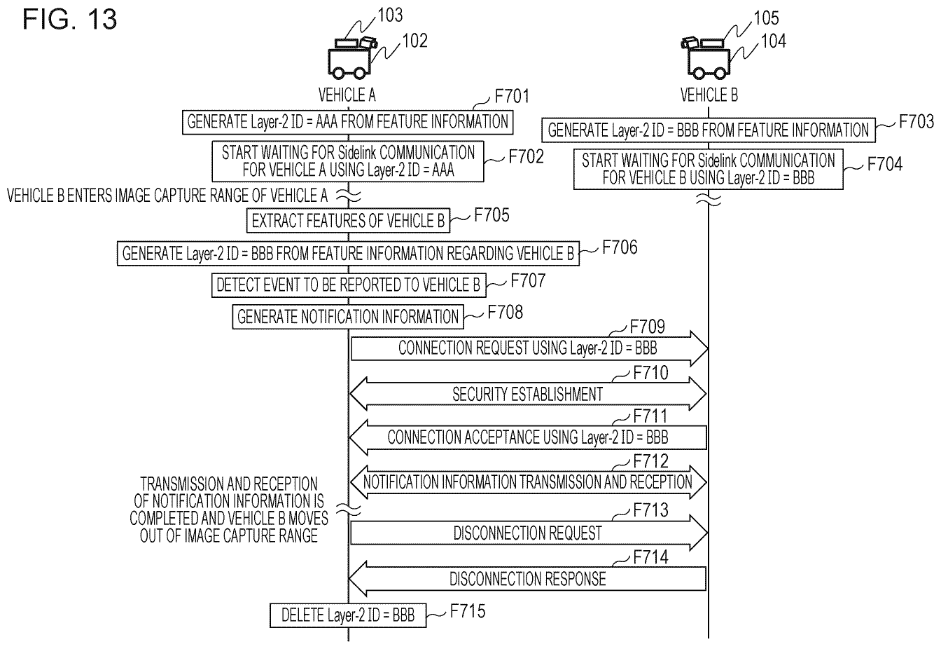

FIG. 13 is a sequence diagram illustrating a sequence related to communication processing performed interactively between the two in-vehicle devices 103 and 105.

Each of the in-vehicle devices 103 and 105 generates the Layer-2 ID for reception from the feature information regarding a corresponding one of the vehicles 102 and 104 that are equipped with the in-vehicle devices 103 and 105, respectively (F701, F703). In the example illustrated in FIG. 13, the in-vehicle device 103 of vehicle A generates a Layer-2 ID such as “AAA”, for example, as a Layer-2 ID for reception. Moreover, the in-vehicle device 105 of vehicle B generates a Layer-2 ID such as “BBB”, for example, as a Layer-2 ID for reception. Each of the in-vehicle devices 103 and 105 starts waiting for Sidelink communication using the generated Layer-2 ID (F702, F704).

Thereafter, when one of vehicles A and B enters the image capture range of the camera 301 of the in-vehicle device 103 or 105 of the other one of vehicles A and B, features are extracted from images captured by the camera 301 (F705). FIG. 13 illustrates an example in which vehicle B enters the image capture range of the in-vehicle device 103 of vehicle A. The in-vehicle device 103 of vehicle A generates a Layer-2 ID for transmission from feature information indicating the extracted features of vehicle B (F706).

When the in-vehicle device 103 of vehicle A detects an event that is to be reported to vehicle B on the basis of information obtained through image capture performed by the camera 301 (F707), the in-vehicle device 103 generates notification information (F708). To transmit the notification information to the in-vehicle device 105 of vehicle B, the in-vehicle device 103 of vehicle A requests a connection using the Layer-2 ID generated in F706 (F709). When, for example, the Layer-2 ID used in the connection request matches the waiting Layer-2 ID, the in-vehicle device 105 of vehicle B accepts the exchange of security information.

When the in-vehicle device 105 of vehicle B accepts the exchange of security information, security is established between the in-vehicle devices 103 and 105 (F710), and a connection acceptance is transmitted from the in-vehicle device 105 of vehicle B to vehicle A (F711).

The in-vehicle device 103 that has received the connection acceptance transmits the notification information to the in-vehicle device 105 of vehicle B, and the in-vehicle device 105 of vehicle B receives the notification information (F712).

When all notification information has been transmitted and received and vehicle B moves out of the image capturable range of the camera 301 in the in-vehicle device 103 of vehicle A, the in-vehicle device 103 of vehicle A requests disconnection of Sidelink communication (F713). When the in-vehicle device 105 of vehicle B accepts the disconnection request (F714), the Sidelink communication is disconnected.

After the Sidelink communication is disconnected, the in-vehicle device 103 of vehicle A deletes the Layer-2 ID generated in F706 (F715).

Next, the processing operation of each device that realizes the above-described sequence will be described with reference to flowcharts.

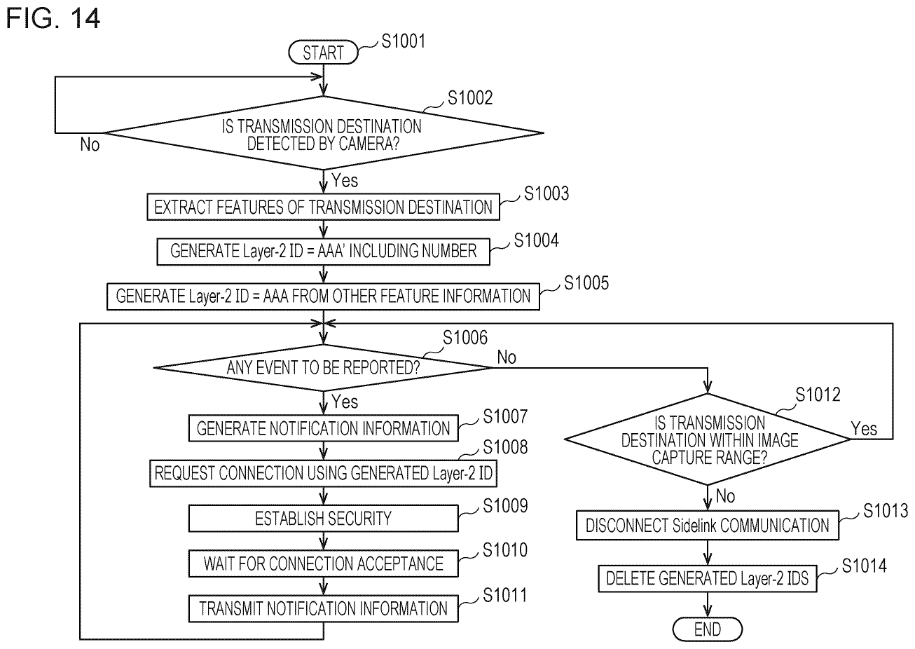

FIG. 14 is a flowchart illustrating a processing operation performed when the roadside device 101 or the like serves as a transmission device that transmits notification information. The transmission destination of notification information is the vehicle 102 or 104, the pedestrian 106, or the bicycle 108.

The processing operation starts in S1001. When the camera 201 or 301 of the roadside device 101 or the like detects a transmission destination (S1002), the feature extraction unit 206 or 306 extracts features of the transmission destination (S1003).

In a case where the extracted features include the vehicle number of the vehicle 102 or 104 or bicycle 108, a Layer-2 ID including the vehicle number as feature information is generated (S1004). In a case where the extracted features do not include a vehicle number, a Layer-2 ID is not generated in S1004, and a Layer-2 ID is generated from feature information indicating features other than a vehicle number (S1005). In S1004, for example, the Layer-2 ID illustrated in FIG. 7 is generated. In S1005, for example, the Layer-2 ID illustrated in FIG. 5 is generated.

As described above, a vehicle number is an excellent feature as a transmission destination. Thus, in the example in FIG. 14, the vehicle number and other features are distinguished from each other to generate a Layer-2 ID. Note that the feature information used to generate a Layer-2 ID may be changed in accordance with, for example, the traffic conditions indicated by notification information. In that case, multiple Layer-2 ID formats may be predetermined and implemented in transmission and reception devices, or the formats may be transmitted via communication.

After the Layer-2 ID is generated, when an event to be reported to the transmission destination occurs (S1006), notification information is generated (S1007). Since the notification information is transmitted to the transmission destination via Sidelink communication, a connection is requested to the transmission destination using the Layer-2 IDs generated in S1004 and S1005 (S1008). Thereafter, the operation of establishing security for Sidelink communication is performed (S1009), and a connection acceptance for Sidelink communication is received from the transmission destination (S1010).

After receiving the connection acceptance, the notification information is transmitted to the transmission destination (S1011). When the transmission of the notification information is complete and the transmission destination moves out of the image capturable range of the camera 201 or 301 (S1012; No), Sidelink communication with the transmission destination is disconnected (S1013). The generated Layer-2 IDs are then deleted (S1014), and the processing operation in FIG. 14 ends. Note that in a case where an event to be reported to the transmission destination does not occur (S1006; No) and the transmission destination moves out of the image capturable range of the camera 201 or 301 (S1012; No), the processing operation also ends after S1013 and S1014.

While the transmission destination is within the image capturable range of the camera 201 or 301 (S1012; Yes), notification information is transmitted every time an event to be reported to the transmission destination occurs (S1006 to S1011).

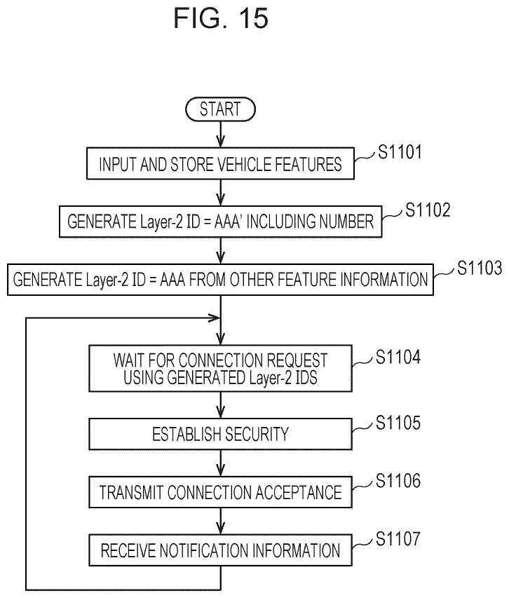

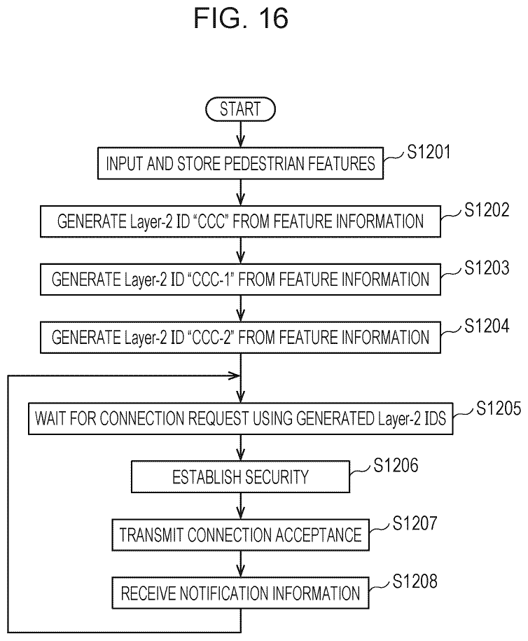

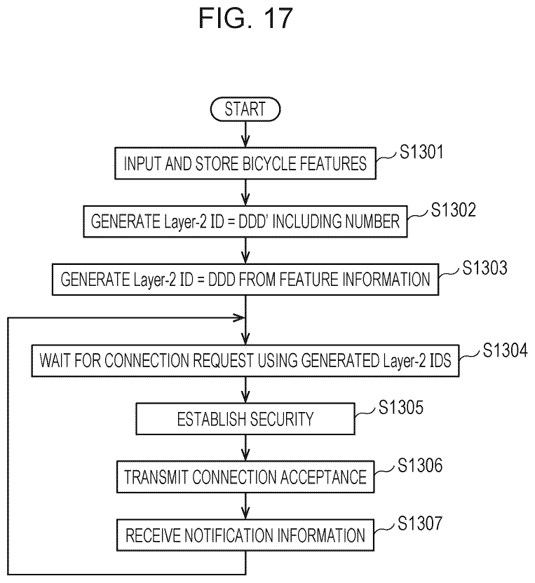

FIGS. 15 to 17 are flowcharts illustrating processing operations performed in a case where the in-vehicle device 103 or the like serves as a reception device that receives notification information. FIG. 15 illustrates a processing operation performed by the in-vehicle device 103 of vehicle A, representing the two in-vehicle devices 103 and 105. FIG. 16 illustrates processing performed by the communication device 107 of the pedestrian 106. FIG. 17 illustrates processing performed by the communication device 109 of the bicycle 108.

When the features of the vehicle 102, pedestrian 106, or bicycle 108 are manually or automatically input to the in-vehicle device 103 or the like, feature information indicating the input features is stored in the memory unit 302 (S1101, S1201, S1301).

The in-vehicle device 103 or the like generates one or more Layer-2 IDs from the feature information.

For example, the in-vehicle device 103 generates a Layer-2 ID “AAA′” including the vehicle number (S1102) and also generates a Layer-2 ID “AAA” including feature information indicating a feature other than the vehicle number (S1103).

For example, the communication device 107 of the pedestrian 106 generates three Layer-2 IDs “CCC”, “CCC-1”, and “CCC-2” corresponding to three types of feature information (S1202, S1203, S1204).

Moreover, for example, the communication device 109 of the bicycle 108 generates a Layer-2 ID “DDD′” including a vehicle number (S1302) and also generates a Layer-2 ID “DDD” including feature information indicating a feature other than the vehicle number (S1303).

After the Layer-2 IDs are generated, the in-vehicle device 103 or the like starts waiting for a connection request for Sidelink communication using the generated Layer-2 IDs (S1104, S1205, S1304).

Upon receiving a connection request in S1104, S1205, or S1304, the in-vehicle device 103 or the like establishes security in Sidelink communication (S1105, S1206, S1305) and transmits a connection acceptance to the request source (S1106, S1207, S1306).

When the connection is completed based on the connection acceptance, the in-vehicle device 103 or the like receives notification information (S1107, S1208, S1307), and returns to the waiting state of S1104, S1205, or S1304 when the reception is completed.

In the communication system 10, the notification information transmitted and received via Sidelink communication indicates, for example, the surrounding traffic conditions detected on the basis of information from sensors and cameras. The notification information may be alert information based on future predictions or may also be data from sensors or images from cameras.

In the communication system 10, the transmission and reception of notification information enables, for example, the vehicles 102 and 104 to grasp not only the presence or absence of oncoming vehicles at the merge point but also the movement of oncoming vehicles based on position and speed information, for example, which makes it possible to provide driver assistance.

In addition, notification information in the communication system 10 can be exchanged with low latency through Sidelink communication, which enables, for example, merging sequence control and emergency braking control in the vehicles 102 and 104.

Furthermore, the transmission and reception of notification information enables safer driving by allowing, for example, the vehicles 102 and 104 to learn in advance road traffic information such as accidents, traffic congestions, emergency vehicles, construction work vehicles, abnormally moving vehicles, as well as the movements of the pedestrian 106 and the bicycle 108.

In the communication system 10, the pedestrian 106 and the bicycle 108 can learn in advance about dangerous movements of the vehicles 102 and 104 around them by transmitting and receiving notification information, thereby reducing the possibility of being involved in an accident.

### OTHER EMBODIMENTS

The present invention can be implemented as embodiments such as a system, a device, a method, a program, or a recording medium (storage medium), for example. Specifically, the present invention may be applied to a system formed by multiple devices (for example, a host computer, an interface device, a web application, and the like) or to an apparatus formed by a single device.

Moreover, the present invention can also be realized by supplying a program (computer program) that realizes one or more functions of the embodiments described above to a system or apparatus via a network or recording medium (storage medium). One or more processors in the computer of that system or apparatus read out and execute the program. In this case, the program (program code) itself that is read out from the recording medium will realize the functions of the embodiments. A recording medium in which the program is recorded may also be included in the present invention.

In addition, not only are the functions of the embodiments realized by a computer reading out and executing the program, but an operating system (OS), for example, running on the computer may also perform part or all of the actual processing on the basis of the instructions of the program to realize the functions of the embodiments described above through that processing.

Furthermore, the program read out from the recording medium is written into the memory of a function expansion card inserted into the computer or into the memory of a function expansion unit connected to the computer, and thereafter the CPU, for example, included in the function expansion card or function expansion unit may perform part or all of the actual processing on the basis of the instructions of the program to realize the functions of the above-described embodiments through that processing.

In a case where the present invention is applied to the above-described recording medium, that recording medium will store a program or programs corresponding to the flowcharts described earlier.

According to an aspect of the present invention, it is possible to achieve Sidelink communication with a specific communication partner even in locations where there are multiple possible communication partners.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device comprising:
an extraction unit that extracts, from a captured image, a feature of a transmission destination present in the captured image;
a generation unit that generates a Layer-2 ID including feature information indicating the feature; and
a transmission unit that transmits information via Sidelink communication using the Layer-2 ID.

2. A communication device comprising:
a storage unit that stores a feature that is extractable from a captured image, the feature being a feature of a loading body equipped with the communication device; and
a reception unit that receives information via Sidelink communication using a Layer-2 ID including feature information indicating the feature.

3. The communication device according to claim 2, comprising: a generation unit that generates the Layer-2 ID.

4. The communication device according to claim 1, wherein the Sidelink communication is Sidelink communication (PC5) defined by 3rd Generation Partnership Project (3GPP), and
the Layer-2 ID is an identifier indicating a communication destination in Sidelink communication defined by the 3GPP.

5. The communication device according to claim 1, wherein at least one of a vehicle number, a vehicle type, a vehicle body shape, a vehicle body color, a direction of travel, a speed, a position, an occupant count, an indicator lamp lighting status, and a brake lamp lighting status of a vehicle is used as the feature.

6. The communication device according to claim 5, wherein the vehicle number is used as the feature.

7. The communication device according to claim 1, wherein at least one of clothing, a hairstyle, a skin color, a gender, a walking direction, a speed, and a position of a pedestrian is used as the feature.

8. The communication device according to claim 1, wherein at least one of a vehicle type, a vehicle body shape, a wheel count, a vehicle body color, rider clothing, a rider clothing color, a direction of travel, a speed, and a location of a bicycle is used as the feature.

9. The communication device according to claim 2, wherein in a case where, regarding a Layer-2 ID including a plurality of pieces of the feature information, all or some of the plurality of pieces of feature information are feature information indicating a feature of the loading body,
the reception unit receives information using the Layer-2 ID.

10. The communication device according to claim 1, wherein the Layer-2 ID is discarded after the information is transmitted.

11. A communication system comprising: a first communication device; and a second communication device, wherein
the first communication device includes
an extraction unit that extracts, from a captured image, a feature of a transmission destination present in the captured image,
a generation unit that generates a Layer-2 ID including feature information indicating the feature, and
a transmission unit that transmits information via Sidelink communication using the Layer-2 ID, and
the second communication device includes
a storage unit that stores a feature that is extractable from a captured image, the feature being a feature of a loading body equipped with the second communication device, and
a reception unit that receives information via Sidelink communication using a Layer-2 ID including feature information indicating the feature.

12. A communication device control method comprising:
extracting, from a captured image, a feature of a transmission destination present in the captured image;
generating an identification (ID) including feature information indicating the feature; and
transmitting information to the transmission destination using the ID.

13. A non-transitory computer readable medium storing a program causing a computer to function as:
an extraction unit that extracts, from a captured image, a feature of a transmission destination present in the captured image;
a generation unit that generates a Layer-2 ID including feature information indicating the feature; and
a transmission unit that transmits information via Sidelink communication using the Layer-2 ID.
